(19) United States
(12) Patent Application Publication
(10) Pub. No.: US 2026/0197260 A1
(43) Pub. Date: Jul. 9, 2026

(54) REPORTING TECHNIQUES FOR BACKSCATTER CAPABILITY WITH FREQUENCY SHIFT

(71) Applicant: QUALCOMM Incorporated, San Diego, CA (US)

(72) Inventors: Xiaojie WANG, Hillsborough, NJ (US); Luanxia YANG, Beijing (CN); Junyi LI, Fairless Hills, PA (US); Xiaoxia ZHANG, San Diego, CA (US)

(21) Appl. No.: 19/133,521

(22) PCT Filed: Feb. 2, 2023
(86) PCT No.: PCT/CN2023/074195

§ 371 Date: May 28, 2025

(51) Int. Cl. H04L 43/065; H04L 5/00

(52) U.S. Cl. CPC H04L 43/065; H04L 5/0048

(57) ABSTRACT

Methods, systems, and devices for wireless communications are described that provide for signaling backscatter modulation capabilities of a user equipment (UE) or other device that supports backscatter modulation. Backscatter modulation capabilities may include frequency shift capabilities, and one or more backscatter capabilities may be signaled in a capability report that is transmitted responsive to a signal from a network node or other interrogating device or reader. The capability report may indicate whether backscatter modulation with frequency shifting is supported or not supported at the UE. The capability report also may indicate one or more types of frequency shifting supported at the UE. The network node may receive the capability report and schedule a UE for communications based on the reported capabilities.

### CROSS REFERENCE

The present Application is a 371 national phase filing of International PCT Application No. PCT/CN2023/074195 by WANG et al., entitled “REPORTING TECHNIQUES FOR BACKSCATTER CAPABILITY WITH FREQUENCY SHIFT,” filed Feb. 2, 2023, which is assigned to the assignee hereof, and which is expressly incorporated by reference in its entirety herein.

### FIELD OF TECHNOLOGY

The following relates to wireless communications, including reporting techniques for backscatter capability with frequency shift.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, such as some Internet-of-Things (IoT) systems, low-cost and low-complexity wireless devices may be desirable in order to provide wireless connectivity to a wide range of devices. Efficient and cost-effective techniques for providing wireless connectivity are thus desirable.

### SUMMARY

The described techniques relate to improved methods, systems, devices, and apparatuses that support reporting techniques for backscatter capability with frequency shift. For example, the described techniques provide for signaling backscatter modulation capabilities of a user equipment (UE), or other device that supports backscatter modulation. In accordance with techniques discussed herein, backscatter modulation capabilities may include frequency shift capabilities, and one or more backscatter capabilities may be signaled in a capability report that is transmitted responsive to a signal from a network node or other interrogating device/reader. In some aspects, the capability report may indicate whether backscatter modulation with frequency shifting is supported or not supported at the UE. Further, the capability report may indicate one or more types of frequency shifting that may be supported at the UE. The network node may receive the capability report and schedule a UE for communications based on the reported capabilities.

A method for wireless communication at a user equipment (UE) is described. The method may include transmitting a backscatter capability report to a network node that includes one or more backscatter modulation capabilities of the UE, the one or more backscatter modulation capabilities including one or more frequency shift capabilities for frequency shifting a reflected signal using backscatter modulation and communicating with the network node using backscatter modulation based on the one or more backscatter modulation capabilities of the UE indicated in the backscatter capability report.

An apparatus for wireless communication at a UE is described. The apparatus may include a processor, memory coupled with the processor, and instructions stored in the memory. The instructions may be executable by the processor to cause the apparatus to transmit a backscatter capability report to a network node that includes one or more backscatter modulation capabilities of the UE, the one or more backscatter modulation capabilities including one or more frequency shift capabilities for frequency shifting a reflected signal using backscatter modulation and communicate with the network node using backscatter modulation based on the one or more backscatter modulation capabilities of the UE indicated in the backscatter capability report.

Another apparatus for wireless communication at a UE is described. The apparatus may include means for transmitting a backscatter capability report to a network node that includes one or more backscatter modulation capabilities of the UE, the one or more backscatter modulation capabilities including one or more frequency shift capabilities for frequency shifting a reflected signal using backscatter modulation and means for communicating with the network node using backscatter modulation based on the one or more backscatter modulation capabilities of the UE indicated in the backscatter capability report.

A non-transitory computer-readable medium storing code for wireless communication at a UE is described. The code may include instructions executable by a processor to transmit a backscatter capability report to a network node that includes one or more backscatter modulation capabilities of the UE, the one or more backscatter modulation capabilities including one or more frequency shift capabilities for frequency shifting a reflected signal using backscatter modulation and communicate with the network node using backscatter modulation based on the one or more backscatter modulation capabilities of the UE indicated in the backscatter capability report.

Some examples of the method, apparatuses, and non-transitory computer-readable medium described herein may further include operations, features, means, or instructions for receiving a signal that triggers the backscatter capability report, and where the transmitting is responsive to the signal. In some examples of the method, apparatuses, and non-transitory computer-readable medium described herein, the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof.

Some examples of the method, apparatuses, and non-transitory computer-readable medium described herein may further include operations, features, means, or instructions for receiving, subsequent to the transmitting the backscatter capability report, an interrogation signal that initiates backscatter modulated communications based on the one or more frequency shift capabilities of the UE, and where the communicating with the network node is responsive to the interrogation signal. In some examples of the method, apparatuses, and non-transitory computer-readable medium described herein, the backscatter capability report indicates that a frequency shift capability at the UE is enabled or disabled.

Some examples of the method, apparatuses, and non-transitory computer-readable medium described herein may further include operations, features, means, or instructions for determining one or more of an energy state or an available power at the UE and requesting to disable communications with the network node using frequency shifted backscatter modulation based on one or more of the energy state or the available power at the UE. In some examples of the method, apparatuses, and non-transitory computer-readable medium described herein, the backscatter capability report further includes a requested amount of power of an interrogation signal from the network node for performing backscatter modulation with a frequency shift.

In some examples of the method, apparatuses, and non-transitory computer-readable medium described herein, the backscatter capability report indicates that the UE performs frequency shifting of the reflected signal from the UE using a square wave generated at the UE or a sinusoidal wave generated using a local oscillator of the UE. In some examples of the method, apparatuses, and non-transitory computer-readable medium described herein, the backscatter capability report further indicates one or more parameters associated with a frequency or clock stability, an expected offset between the frequency or clock and an interrogation signal frequency, or any combinations thereof. In some examples of the method, apparatuses, and non-transitory computer-readable medium described herein, the backscatter capability report further indicates, for frequency shifting using the square wave, one or more of a jitter range or the expected offset associated with generating the square wave. In some examples of the method, apparatuses, and non-transitory computer-readable medium described herein, the backscatter capability report further indicates, for frequency shifting using the local oscillator, one or more of a phase noise class or the expected offset associated with generating the sinusoidal wave.

Some examples of the method, apparatuses, and non-transitory computer-readable medium described herein may further include operations, features, means, or instructions for receiving an indication of one or more frequency shift parameters for the communicating with the network node. In some examples of the method, apparatuses, and non-transitory computer-readable medium described herein, the backscatter capability report indicates a frequency hopping capability of the UE for frequency shifting the reflected signal from the UE using backscatter modulation. In some examples of the method, apparatuses, and non-transitory computer-readable medium described herein, the frequency hopping capability includes an indication of one or more of a switching gap time supported at the UE, a number of frequency hops supported at the UE, one or more hopping patterns supported at the UE, or any combinations thereof.

A method for wireless communication at a network node is described. The method may include receiving, from a UE, a backscatter capability report that indicates one or more backscatter modulation capabilities of the UE, the one or more backscatter modulation capabilities including one or more frequency shift capabilities for frequency shifting a reflected signal using backscatter modulation and communicating with the UE using backscatter modulation based on the one or more backscatter modulation capabilities of the UE indicated in the backscatter capability report.

An apparatus for wireless communication at a network node is described. The apparatus may include a processor, memory coupled with the processor, and instructions stored in the memory. The instructions may be executable by the processor to cause the apparatus to receive, from a UE, a backscatter capability report that indicates one or more backscatter modulation capabilities of the UE, the one or more backscatter modulation capabilities including one or more frequency shift capabilities for frequency shifting a reflected signal using backscatter modulation and communicate with the UE using backscatter modulation based on the one or more backscatter modulation capabilities of the UE indicated in the backscatter capability report.

Another apparatus for wireless communication at a network node is described. The apparatus may include means for receiving, from a UE, a backscatter capability report that indicates one or more backscatter modulation capabilities of the UE, the one or more backscatter modulation capabilities including one or more frequency shift capabilities for frequency shifting a reflected signal using backscatter modulation and means for communicating with the UE using backscatter modulation based on the one or more backscatter modulation capabilities of the UE indicated in the backscatter capability report.

A non-transitory computer-readable medium storing code for wireless communication at a network node is described. The code may include instructions executable by a processor to receive, from a UE, a backscatter capability report that indicates one or more backscatter modulation capabilities of the UE, the one or more backscatter modulation capabilities including one or more frequency shift capabilities for frequency shifting a reflected signal using backscatter modulation and communicate with the UE using backscatter modulation based on the one or more backscatter modulation capabilities of the UE indicated in the backscatter capability report.

Some examples of the method, apparatuses, and non-transitory computer-readable medium described herein may further include operations, features, means, or instructions for transmitting a signal to the UE that requests the backscatter capability report.

In some examples of the method, apparatuses, and non-transitory computer-readable medium described herein, the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof. Some examples of the method, apparatuses, and non-transitory computer-readable medium described herein may further include operations, features, means, or instructions for transmitting, subsequent to the receiving the backscatter capability report, an interrogation signal that initiates backscatter modulated communications based on the one or more frequency shift capabilities of the UE, and where the communicating with the UE is responsive to the interrogation signal.

Some examples of the method, apparatuses, and non-transitory computer-readable medium described herein may further include operations, features, means, or instructions for receiving a request to disable communications with the network node using frequency shifted backscatter modulation and discontinuing communications with the UE using frequency shifted backscatter modulation. In some examples of the method, apparatuses, and non-transitory computer-readable medium described herein, the backscatter capability report further includes a requested amount of power of an interrogation signal from the network node, and a power of the interrogation signal is determined based on the requested amount of power.

In some examples of the method, apparatuses, and non-transitory computer-readable medium described herein, the backscatter capability report indicates that the UE performs frequency shifting of the reflected signal from the UE using a square wave generated at the UE or a sinusoidal wave generated using a local oscillator of the UE, and the communicating with the UE is based on the square wave or sinusoidal wave frequency shifting of the UE. In some examples of the method, apparatuses, and non-transitory computer-readable medium described herein, the backscatter capability report indicates an amount of frequency shift supported for frequency shifting the reflected signal from the UE using backscatter modulation. In some examples of the method, apparatuses, and non-transitory computer-readable medium described herein, the backscatter capability report indicates a frequency hopping capability of the UE for frequency shifting the reflected signal from the UE using backscatter modulation.

### BRIEF DESCRIPTION OF THE DRAWINGS

FIG. 1 illustrates an example of a wireless communications system that supports reporting techniques for backscatter capability with frequency shift in accordance with one or more aspects of the present disclosure.

FIG. 2 illustrates an example of a wireless communications system that supports reporting techniques for backscatter capability with frequency shift in accordance with one or more aspects of the present disclosure.

FIG. 3 illustrates an example of a backscattering device without frequency shift in accordance with one or more aspects of the present disclosure.

FIG. 4 illustrates an example of a backscattering device with frequency shift that supports reporting techniques for backscatter capability with frequency shift in accordance with one or more aspects of the present disclosure.

FIG. 5 illustrates an example of a frequency hopping scheme that supports reporting techniques for backscatter capability with frequency shift in accordance with one or more aspects of the present disclosure.

FIG. 6 illustrates an example of a process flow that supports reporting techniques for backscatter capability with frequency shift in accordance with one or more aspects of the present disclosure.

FIGS. 7 and 8 illustrate block diagrams of devices that support reporting techniques for backscatter capability with frequency shift in accordance with one or more aspects of the present disclosure.

FIG. 9 illustrates a block diagram of a communications manager that supports reporting techniques for backscatter capability with frequency shift in accordance with one or more aspects of the present disclosure.

FIG. 10 illustrates a diagram of a system including a device that supports reporting techniques for backscatter capability with frequency shift in accordance with one or more aspects of the present disclosure.

FIGS. 11 and 12 illustrate block diagrams of devices that support reporting techniques for backscatter capability with frequency shift in accordance with one or more aspects of the present disclosure.

FIG. 13 illustrates a block diagram of a communications manager that supports reporting techniques for backscatter capability with frequency shift in accordance with one or more aspects of the present disclosure.

FIG. 14 illustrates a diagram of a system including a device that supports reporting techniques for backscatter capability with frequency shift in accordance with one or more aspects of the present disclosure.

FIGS. 15 through 21 illustrate flowcharts showing methods that support reporting techniques for backscatter capability with frequency shift in accordance with one or more aspects of the present disclosure.

### DETAILED DESCRIPTION

In some wireless communications systems, such as some Internet-of-Things (IoT) systems, low-cost and low-complexity wireless devices may be desirable in order to provide wireless connectivity to a wide range of devices. One type of relatively low-cost and relatively low-complexity device that may be used in such systems may radio frequency identification (RFID) techniques for communications. In some cases, devices may have a RFID component that is in addition to RF components that enable other types of wireless communications (e.g., 5G or New Radio (NR) communications, Wi-Fi communications, device-to-device communications, etc.). In some cases, one or more device may not be capable of other types of wireless communications, and may rely only on RFID type communications. Such RFID techniques are relatively low power communications, and may use backscatter modulation, which allows for larger distances between devices, or inductive coupling for more near-field communications. In systems that use backscatter modulation, an interrogation signal from an interrogating device (e.g., a network node or network device such as a remote radio head (RRH)) is reflected back to the interrogating device with information modulated on the reflected signal. The information may modulated, such as using ASK or PSK, on the backscattered signal and antenna impedance may switched to adjust a reflection coefficient for absorbing or reflecting the impinging electromagnetic (EM) wave in accordance with the modulation technique (e.g., ASK/PSK). Such techniques allow a device, such as a UE, with a backscattering component to consume relatively little power, as most of the energy used in the procedure is provided by the interrogating device.

In some cases, the backscattered signal may use a same frequency as the interrogation signal, which may result in interference at the interrogating device, which may reduce communications efficiency and reliability. Some RFID devices use frequency shifting to avoid this interference, and systems that use such frequency shifting techniques may have hardware specifications that dictate the types of devices that can communicate using the system. However, such specified operation provides very little flexibility in the types of devices and types of frequency shifting that can be used in such a system. In accordance with various aspects discussed herein, a device may report frequency shifting capabilities for backscatter communications. Such aspects may provide for additional flexibility and capabilities of a system and provide for devices that implement low-cost and low-complexity connectivity (e.g., in IoT systems). Further, such techniques may allow for numerous different types of devices that have varying different capabilities to communicate with a same network node.

In accordance with various aspects, techniques are provided for signaling backscatter modulation capabilities of a UE (or other device), including frequency shift capabilities. While various examples discussed herein may reference a UE that performs backscatter modulation, techniques as discussed herein may be used in any device that implements backscatter communications. In some aspects, the backscatter capability may be signaled in a capability report that is transmitted responsive to a signal from a network node (e.g., a wakeup signal or other interrogation signal that triggers a capability report). While various examples discussed herein may reference a network device or network node that performs interrogation and communicates using backscatter modulation, techniques as discussed herein may be used in any interrogating device that implements backscatter communications. In some aspects, the capability report may indicate whether backscatter modulation with frequency shifting is supported or not supported at the UE. Further, the capability report may indicate one or more types of frequency shifting that may be supported at the UE. The different types of frequency shifting may include an amount of frequency change supported, whether the UE supports a double-side shift (e.g., +&−delta_frequency) or a single-side shift (e.g., + or − delta_frequency), whether the UE uses a square wave or local oscillator to generate frequency shifts, a frequency/clock stability and expected clock offset of the shifted signal, amount of frequency shift supported (e.g., an upper bound of delta_frequency, of discrete frequency shifts available), frequency hopping capability (e.g., switching time, number of hops, and hopping pattern), or any combinations thereof.

An interrogating network node may receive the capability report and schedule a UE for communications based on the reported capabilities. In some cases, the network node may initiate communications based on the indicated capabilities by indicating frequency shift parameters (e.g., using a modulated interrogation signal) such as an amount of frequency shift, frequency hopping pattern, or any combinations thereof, and may use appropriate detection algorithms and scheduling algorithms based on the frequency shift parameters.

Aspects of the disclosure are initially described in the context of wireless communications systems. Aspects of the disclosure are further illustrated by and described with reference to apparatus diagrams, frequency hopping diagrams, process flows, system diagrams, and flowcharts that relate to reporting techniques for backscatter capability with frequency shift.

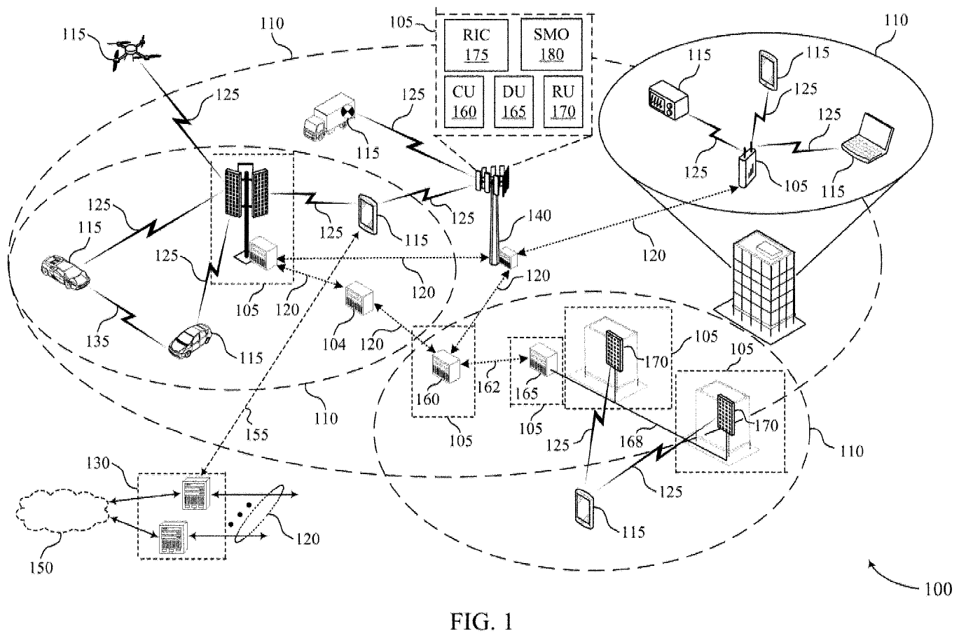

FIG. 1 illustrates an example of a wireless communications system 100 that supports reporting techniques for backscatter capability with frequency shift in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support reporting techniques for backscatter capability with frequency shift as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with some aspects, one or more UEs 115 may include backscatter modulation capabilities, and various described techniques provide for signaling backscatter modulation capabilities of a UE 115 that supports backscatter modulation. In accordance with some techniques discussed herein, backscatter modulation capabilities may include frequency shift capabilities, and one or more backscatter capabilities may be signaled in a capability report that is transmitted responsive to a signal from a network entity 105 or other interrogating device/reader. In some aspects, the capability report may indicate whether backscatter modulation with frequency shifting is supported or not supported at the UE 115. Further, the capability report may indicate one or more types of frequency shifting that may be supported at the UE 115. The network entity 105 may receive the capability report and schedule a UE 115 for communications based on the reported capabilities. In some cases, the capability report may be received via a different wireless interface (e.g., via a 5G Uu interface, a Wi-Fi interface, or a D2D PC5 interface) than an interface that uses backscattering modulation, and the network entity 105 may perform backscatter modulation communications based on the capability report that is received via the different interface.

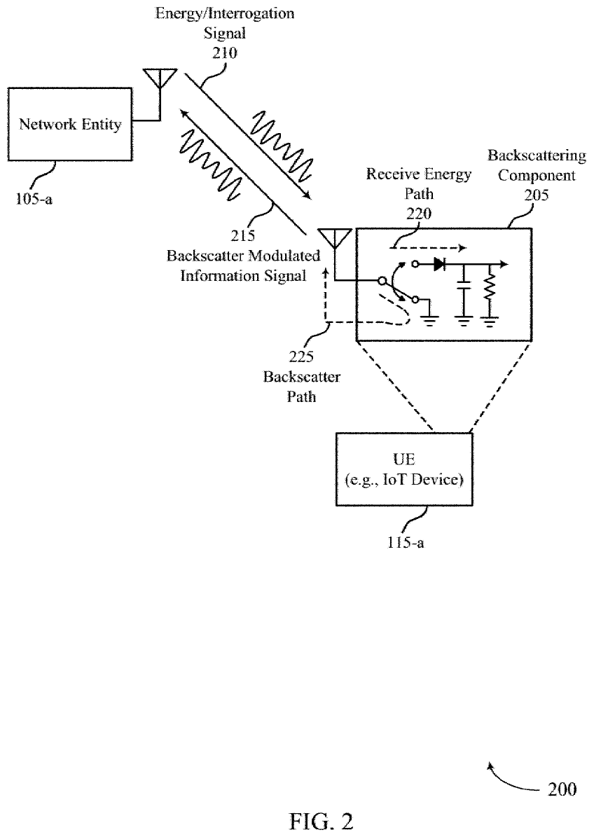

FIG. 2 illustrates an example of a wireless communications system 200 that supports reporting techniques for backscatter capability with frequency shift in accordance with one or more aspects of the present disclosure. The wireless communications system 200 may include a network entity 105-a and a UE 115-a, which may be examples of the corresponding devices described herein with reference to FIG. 1. The network entity 105-a and the UE 115-a may communicate with each other using backscatter modulation, in addition to, or alternatively to, one or more other interfaces that may be available for communication (e.g., a Uu interface, Wi-Fi interface, PC5 interface, etc.). In accordance with the example of FIG. 2, the network entity 105-a may transmit an energy/interrogation signal 210 that may be backscattered at a backscattering component 205 of the UE 115-a, to transmit a backscatter modulated information signal 215 to the network entity 105-a.

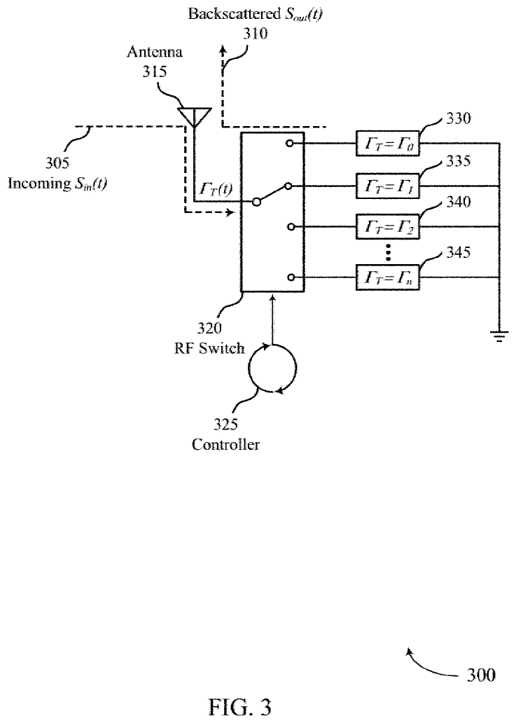

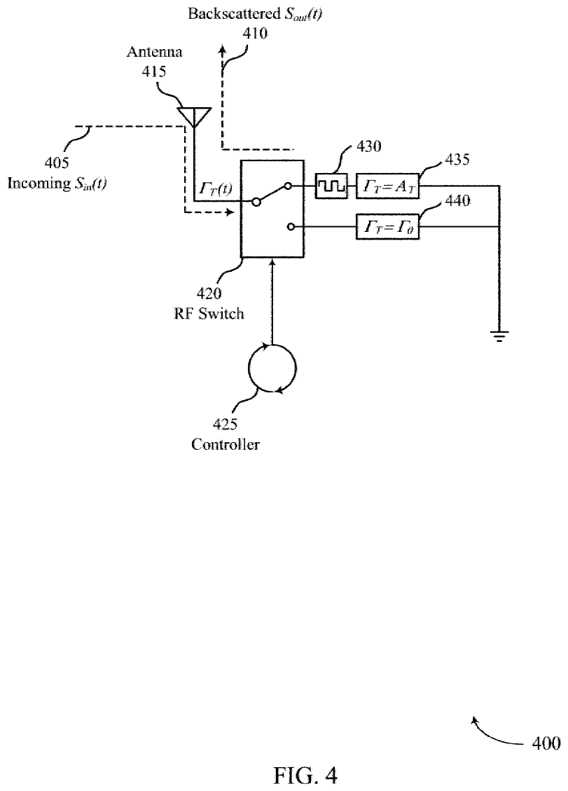

In the example of FIG. 2, the backscattering component 205 of the UE 115-a may receive the energy/interrogation signal 210 and derive all or a portion of operating power for the backscatter modulated information signal 215 from a receive energy path 220 that may harvest energy from the energy/interrogation signal 210. For example, the backscattering component 205 may charge a capacitor using energy from the energy/interrogation signal 210, and use the charge in the capacitor to provide power to one or more components (e.g., an RF switch, square wave generation, oscillator, or any combinations thereof). An RF switch of the backscattering component 205 may switch between different impedances to modulate a reflected signal on a backscatter path 225 to provide the backscatter modulated information signal 215 that may be decoded at the network entity 105-a to obtain transmitted information. In some cases, the backscattering component 205 may be a passive component that does not require an external power source. In other cases, the backscattering component 205 may be an active component that does receive power from an external power source. In some cases, the UE 115-a may provide an RFID-type of sensor (e.g., an active or passive IoT device that may be used in inventory/asset management, logistics, warehousing, manufacturing, sustainable sensor networks at factories, housing, and/or agriculture, etc.). In some cases, the energy/interrogation signal 210 may be used to read information stored at the UE 115-a, write information to be stored at the UE, or any combinations thereof. FIGS. 3 and 4 provide examples of backscatter modulation devices that may be used in accordance with various techniques as discussed herein.

FIG. 3 illustrates an example of a backscattering device 300 without frequency shift in accordance with one or more aspects of the present disclosure. The backscattering device 300 may be used by a transmitting device (e.g., a UE 115 or RFID tag), that may receive an incoming signal 305 and transmit a backscattered signal 310 using backscatter modulation.

In this example, an antenna 315 may receive an incoming signal 305, represented as Sᵢₙ(t), that is provided to an RF switch 320. A controller 325 may switch the incoming signal 305 between different impedances 330 through 345, to generate a reflection that is output through the antenna 315 as backscattered signal 310, represented as Sₒᵤₜ(t). In this example, backscatter without frequency shift is provided, and switching between different impedances 330 through 345 may be performed to modulate the incoming signal 305 according to amplitude shift keying (ASK) or phase shift keying (PSK). In this example, different impedances 330 through 345 may indicate different symbols, which may be demodulated to obtain information bits.

For example, load modulation may be used to provide changing impedance Zᵢ to adjust reflection coefficient for absorbing or reflecting the impinging EM wave (e.g., incoming signal 305) according to

$${Γ}_{i} = \frac{{Z}_{i} - {Z}_{a}^{*}}{{Z}_{i} + {Z}_{a}}$$

where Zₐ is the intrinsic impedance of the antenna 315. For example, Zᵢ may have two or more states for absorbing or reflecting the wave. In some cases, the controller 325 may control the RF switch 320 to provide ASK and/or PSK by switching the impendences 330 through 345. In some cases, the incoming signal 305 and backscattered signal 310 may operate in frequency bands at 902-928 MHz, 2400-2483.5 MHz, and/or 5725-5850 MHz.

In some cases, backscattered communications may provide full-duplex communications at the network node or other reader that transmits the incoming signal 305 and receives the backscattered signal 310. In the example of FIG. 3, the backscattered signal 310 may be in the same band or carrier of the incoming signal 305, and reader-side detection of the backscattered signal 310 may suffer from full-duplex interference. In some cases, such interference may be mitigated through backscatter with frequency shift, such as is illustrated in FIG. 4.

FIG. 4 illustrates an example of a backscattering device 400 with frequency shift that supports reporting techniques for backscatter capability with frequency shift in accordance with one or more aspects of the present disclosure. The backscattering device 400 may be used by a transmitting device (e.g., a UE 115 or RFID tag), that may receive an incoming signal 405 and transmit a backscattered signal 410 using backscatter modulation.

In this example, an antenna 415 may receive an incoming signal 405, represented as Sᵢₙ(t), that is provided to an RF switch 420. A controller 425 may switch the incoming signal 405 between different impedances 435 and 440 to absorb or reflect the signal, and the reflected signal may be frequency shifted by frequency shifter 430, to generate a reflection that is output through the antenna 415 as backscattered signal 410, represented as Sₒᵤₜ(t). In this example, backscatter with frequency shift is provided, and switching between different impedances 435 and 440 may be performed to modulate the incoming signal 405 according to amplitude shift keying (ASK) or phase shift keying (PSK). In this example, different square waves may indicate different symbols, which may be demodulated to obtain information bits. The frequency shifted backscattered signal 410 may provide for reduced interference relative to a non-frequency-shifted signal.

In some examples, such frequency shift techniques may support more modulation schemes, with increased complexity, and larger frequency shifts (Δf) may result in higher energy consumption. Further, a larger range of Δf may lead to an increase in the dynamic power dissipation. For example, from Fourier analysis:

$$square ( {f}_{shift} t ) = \frac{4}{π} {\sum }_{n = 1 , 3 , 5 , …}^{∞} \frac{1}{n} sin ( 2 π n {f}_{shift} t ) .$$

In some cases, a UE may apply frequency shift and perform backscattering using various different techniques, for example, different implementations may use double-sided frequency shift or single-sided frequency shift, which may mitigate full-duplex interference at a reading device depending on the amount of frequency shift applied. In accordance with various aspects, a UE that includes a backscattering component, such as illustrated in FIGS. 3 and 4, may provide signaling that indicates a frequency shift capability of the UE. For example, a capability indication may indicate that no frequency shift is provided (e.g., if no hardware for generating frequency shift signals is present such as illustrated in FIG. 3, or if frequency shifting components such as illustrated in FIG. 4 are not enabled), may indicate a frequency shift and architecture that is used (e.g., a square wave versus sine wave architecture for performing frequency shift), may indicate different amounts of frequency shifts (delta f) supported, may indicate support of double-sided or single-sided shift, may indicate support of frequency hopping, or any combinations thereof. The network entity may obtain the UE capability for performing frequency shift and schedule backscatter modulated communications in accordance with the UE capability (e.g., using different detection algorithms, or different scheduling algorithms for tags with different frequency shift capability).

In some cases, an initial signal, such as a wakeup signal or interrogation signal, may be transmitted by the network entity to trigger a UE to transmit a capability report. In some cases, the capability report may indicate whether the UE supports frequency shift or not, and this feature may also be enabled or disabled by the network entity based on capability. In some cases, a UE may recommend to enable or disable frequency shifting based on an energy state and power consumption at the UE (e.g., if a charge state of a power source of the UE is below a threshold value, the UE may request backscatter communications without frequency shift or with a smaller frequency shift). In some cases, additionally or alternatively, the UE may report a power consumption associated with performing frequency shift, and the network entity may adjust a power level of the incoming signal 405 based on such an indication. Further, in some cases, the capability report may indicate a double-sided (e.g., may shift a signal by ±Δf) or single-sided (e.g., may shift a signal by Δf) architecture. In some cases, the network entity may schedule backscattering and indicate N·Δf.

Additionally, or alternatively, the capability report may indicate whether frequency shifting is implemented with a square wave or an oscillator (e.g., sine wave). In some cases, frequency shift performed with square wave may enable a simpler implementation, but may result in relatively large out-of-band emissions. In some cases, frequency shift may be performed with local oscillator which provides reduced out-of-band emissions, and may have relatively higher power consumption than square wave-based frequency shifting. In some further cases a UE, additionally or alternatively, may report a frequency or clock stability, an expected frequency offset, or any combinations thereof. For example, with a square wave, a square wave On/OFF width jitter range may be reported (e.g., within 1 μs (Class1), 10 μs (Class2), ON duration may vary from 0.99 ms to 1.01 ms for class 2, etc.). A clock for generating the periodic square wave may be subject to clock offset (e.g., 10 ppm (Class 1) or 100 ppm (Class2)), that may be reported in the capability report. In other examples that use a local oscillator (e.g., sine wave), the oscillator may subject to clock offset that may be reported by the UE in the capability report. Further, the UE may be subject to relatively large phase noise (e.g., if low cost components are used), and phase noise may be categorized into different classes (e.g., −50 dBc (Class1) or −80 dBc (Class2) when measured 100 kHz away from the carrier frequency), that may be reported by the UE in the capability report.

In further examples, a UE may indicate supported frequency shifts. For example, a UE may not be able to support arbitrary Δf and may report supported values. For example, the UE may report an upper bound of Δf (e.g., 180 kHz, 1 MHz or 100 MHz), may report discrete frequencies of Δf (e.g., 200 kHz only, or one of {200 KHz, 400 kHz, 1 MHz}), may report constraints of Δf (e.g., it must satisfy Δf=f_{c}/N or Δf=f_{c}/2^{N} or

$$Δ f = \frac{n}{rm \pm 1} fc ,$$

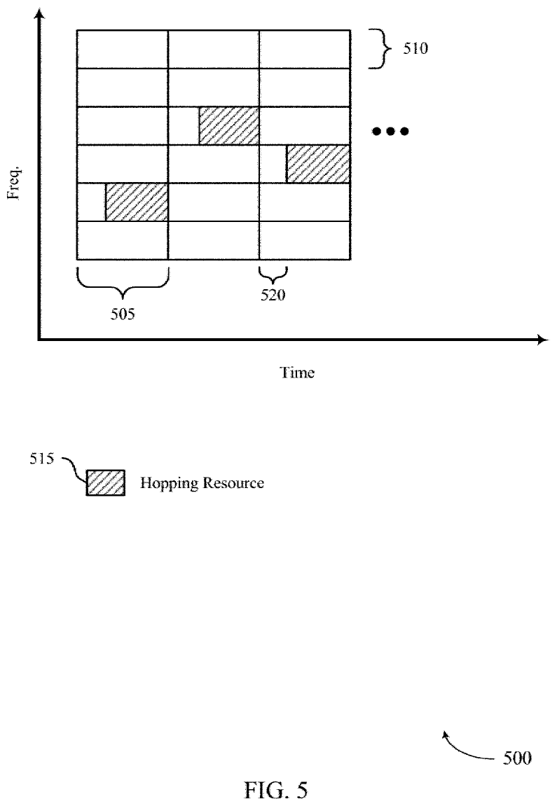

etc., with the parameters, r, m, n, N, provided for different architectures). In some cases, the UE may indicate the Δf for scheduled backscattering by indicate the parameters of r, m, n, N (or combinations of parameters) based on reported capability. Additionally, or alternatively, in some cases a UE may support frequency hopping, such as discussed with reference to FIG. 5

FIG. 5 illustrates an example of a frequency hopping scheme 500 that supports reporting techniques for backscatter capability with frequency shift in accordance with one or more aspects of the present disclosure. The frequency hopping scheme 500 may be used by a transmitting device (e.g., a UE 115 or RFID tag), that may receive an incoming signal 405 and transmit a backscattered signal 410 using backscatter modulation with frequency hopping.

In this example, time resources 505 and frequency resources 510 may be provided that allow for a frequency hopping sequence in different hopping resources 515. In some cases, frequency hopping capabilities may include one or more of a switching time gap 520 between frequency hopping (e.g., from Δf1 to Δf2), a number of supported frequency hops, a hopping pattern supported (e.g., pseudo-random hopping or fixed hopping pattern), or any combinations thereof.

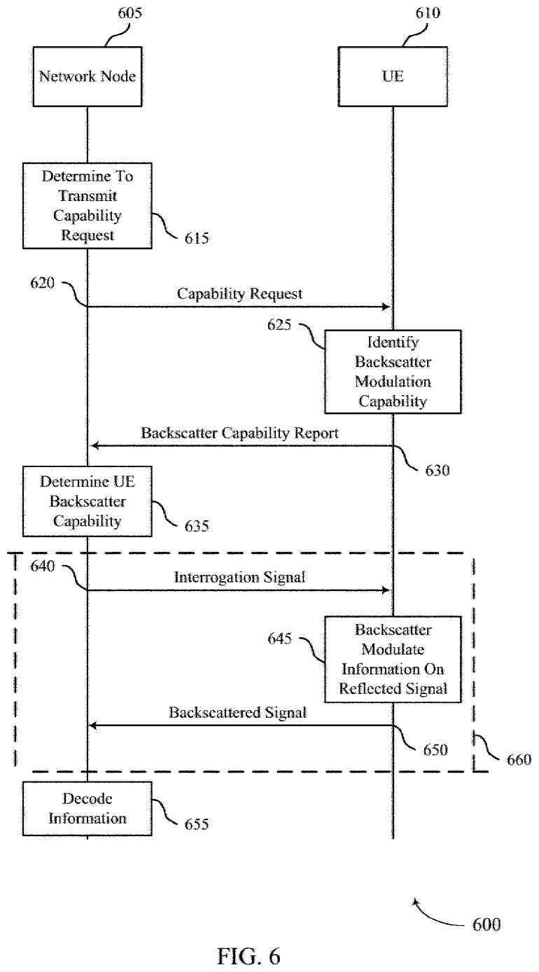

FIG. 6 illustrates an example of a process flow 600 that supports reporting techniques for backscatter capability with frequency shift in accordance with one or more aspects of the present disclosure. The process flow 600 may implement or be implemented by aspects of any of the wireless communications systems, architectures, or resource diagrams described with reference to FIGS. 1 through 5. For example, the process flow 600 includes a network node 605 and a UE 610, each of which may be an example of a UE 115 or a network node or network entity 105, as described herein. In the following description of the process flow 600, operations between the network node 605 and the UE 610 may be added, omitted, or performed in a different order (with respect to the exemplary order shown).

At 615, the network node 605 may determine to transmit a capability request for backscatter modulation capabilities of one or more UEs or other devices/tags. In some cases, the network node 605 may periodically request capabilities, and different responding device may provide associated reports based on a sleep/wake cycle of the responding device. At 620, the network node 605 may transmit the capability request, which may be received at the UE 610. In some cases, the capability request may be transmitted in an interrogation signal that may provide a wakeup signal for backscatter modulation components of the UE 610. In other cases, the capability request may be transmitted using a different interface than the backscatter modulation interface (e.g., via a 5G Uu interface, Wi-Fi interface, PC5 interface, or some other wireless network interface).

At 625, the UE 610 may identify backscatter modulation capabilities. In some cases, the backscatter modulation capabilities may be formatted into a capability report that may indicate one or more of whether frequency shifting is supported, an amount of a frequency shift that is supported, two or more discrete frequency shifts that are supported, a double-side frequency shift capability, a single-side frequency shift capability, a frequency hopping capability, a requested power level or amount of power used for frequency shifting, or any combinations thereof. At 630, the UE 610 may transmit the backscatter capability report to the network node 605.

At 635, the network node 605 may determine a UE backscatter capability based on the backscatter capability report. In some cases, the network node 605 may determine scheduling for performing backscatter communications with the UE 610 based on the backscatter capability report of the UE 610 and one or more other UEs that may provide associated capability reports. For example, the network node 605 may perform different types of backscatter communications with different subsets of UEs based on associated capabilities of the UEs.

At 640, the network node 605 may transmit an interrogation signal to the UE 610 to initiate communications using backscatter modulation. In some cases, the interrogation signal may include modulated information that may be used to indicate one or more particular UEs that are to respond to the interrogation signal (e.g., that indicates UEs with particular IDs are to respond, where each UE that receives the interrogation signal may provide an associated UE ID and the network node 605 may select UE IDs for communication based on associated capability reports of each UE). At 645, the UE 610 may backscatter modulate information on a reflected signal that is provided, at 650, as a backscattered signal to the network node 605. At 655, the network node 605 may decode information from the backscattered signal. For example, the information transmitted via the backscattered signal may include sensor information associated with the UE 610, an asset management ID, and/or an inventory tracking ID, to provide a few non-limiting examples. It is noted that the interrogation signal transmission, backscatter modulation, and backscattered signal transmission, may overlap in time as part of a backscatter modulation operation, as indicated at 660. Likewise, in cases where the capability report is provided using a backscatter modulation, the capability request (and associated interrogation signal) and corresponding capability report transmissions may overlap in time as part of a backscatter modulation operation.

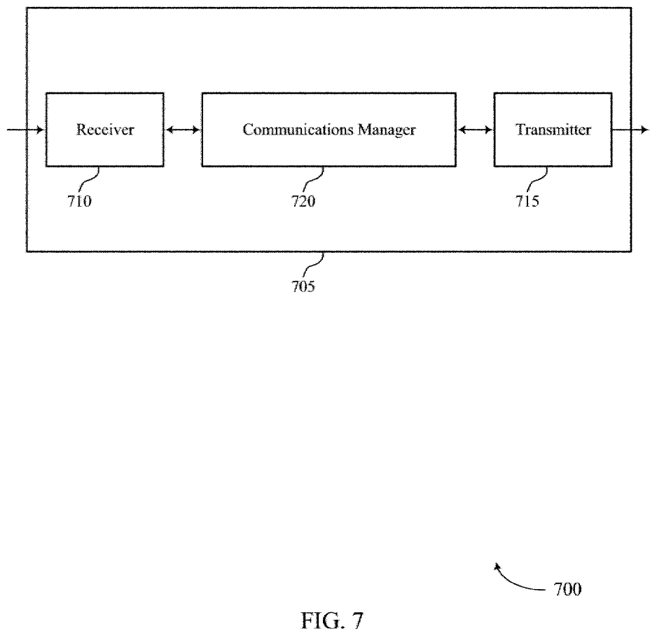

FIG. 7 illustrates a block diagram 700 of a device 705 that supports reporting techniques for backscatter capability with frequency shift in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to reporting techniques for backscatter capability with frequency shift). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to reporting techniques for backscatter capability with frequency shift). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of reporting techniques for backscatter capability with frequency shift as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for transmitting a backscatter capability report to a network node that includes one or more backscatter modulation capabilities of the UE, the one or more backscatter modulation capabilities including one or more frequency shift capabilities for frequency shifting a reflected signal using backscatter modulation. The communications manager 720 may be configured as or otherwise support a means for communicating with the network node using backscatter modulation based on the one or more backscatter modulation capabilities of the UE indicated in the backscatter capability report.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reporting frequency shifting capabilities for backscatter communications, which may provide for additional flexibility and capabilities of a system and provide for a wide variety of devices that implement low-cost and low-complexity connectivity (e.g., in IoT systems).

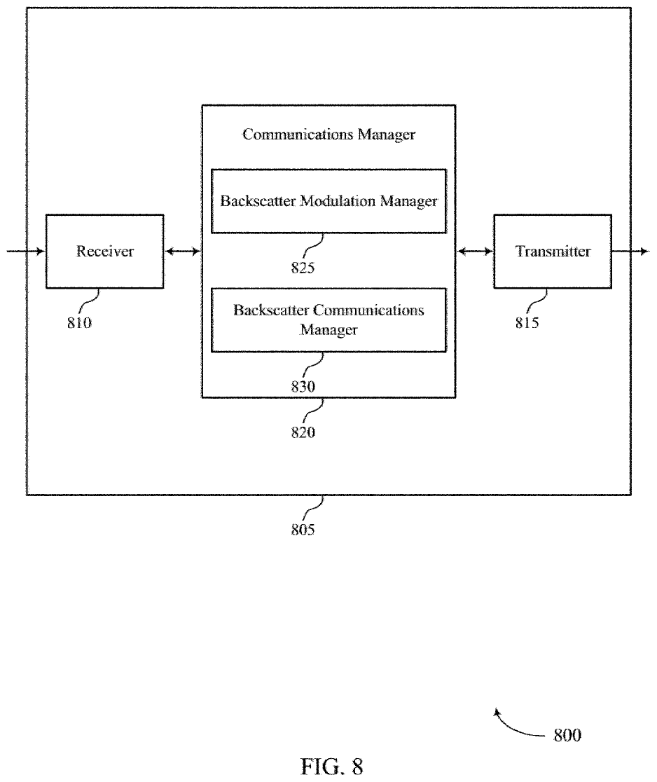

FIG. 8 illustrates a block diagram 800 of a device 805 that supports reporting techniques for backscatter capability with frequency shift in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to reporting techniques for backscatter capability with frequency shift). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to reporting techniques for backscatter capability with frequency shift). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of reporting techniques for backscatter capability with frequency shift as described herein. For example, the communications manager 820 may include a backscatter modulation manager 825 a backscatter communications manager 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The backscatter modulation manager 825 may be configured as or otherwise support a means for transmitting a backscatter capability report to a network node that includes one or more backscatter modulation capabilities of the UE, the one or more backscatter modulation capabilities including one or more frequency shift capabilities for frequency shifting a reflected signal using backscatter modulation. The backscatter communications manager 830 may be configured as or otherwise support a means for communicating with the network node using backscatter modulation based on the one or more backscatter modulation capabilities of the UE indicated in the backscatter capability report.

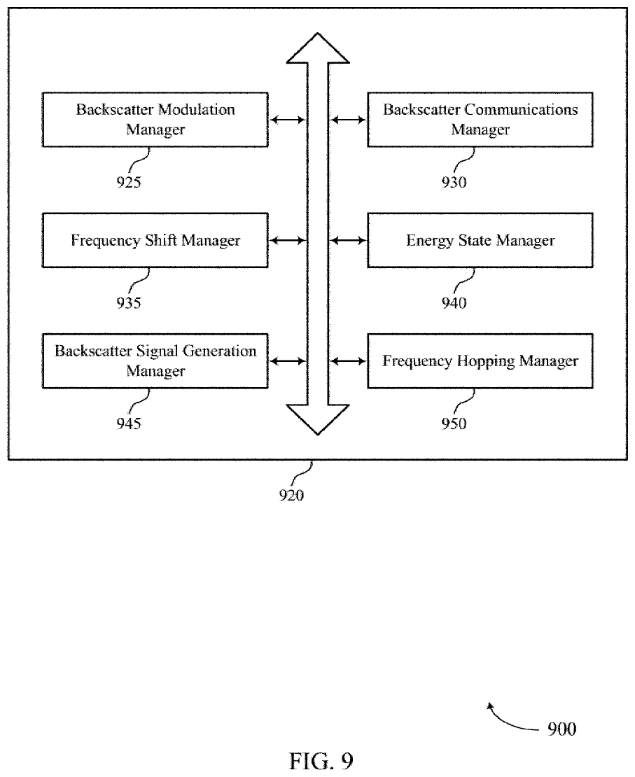

FIG. 9 illustrates a block diagram 900 of a communications manager 920 that supports reporting techniques for backscatter capability with frequency shift in accordance with one or more aspects of the present disclosure. The communications manager 920 may be an example of aspects of a communications manager 720, a communications manager 820, or both, as described herein. The communications manager 920, or various components thereof, may be an example of means for performing various aspects of reporting techniques for backscatter capability with frequency shift as described herein. For example, the communications manager 920 may include a backscatter modulation manager 925, a backscatter communications manager 930, a frequency shift manager 935, an energy state manager 940, a backscatter signal generation manager 945, a frequency hopping manager 950, or any combination thereof. Each of these components may communicate, directly or indirectly, with one another (e.g., via one or more buses).

The communications manager 920 may support wireless communication at a UE in accordance with examples as disclosed herein. The backscatter modulation manager 925 may be configured as or otherwise support a means for transmitting a backscatter capability report to a network node that includes one or more backscatter modulation capabilities of the UE, the one or more backscatter modulation capabilities including one or more frequency shift capabilities for frequency shifting a reflected signal using backscatter modulation. The backscatter communications manager 930 may be configured as or otherwise support a means for communicating with the network node using backscatter modulation based on the one or more backscatter modulation capabilities of the UE indicated in the backscatter capability report.

In some examples, the backscatter communications manager 930 may be configured as or otherwise support a means for receiving a signal that triggers the backscatter capability report, and where the transmitting is responsive to the signal. In some examples, the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof. In some examples, the backscatter communications manager 930 may be configured as or otherwise support a means for receiving, subsequent to the transmitting the backscatter capability report, an interrogation signal that initiates backscatter modulated communications based on the one or more frequency shift capabilities of the UE, and where the communicating with the network node is responsive to the interrogation signal. In some examples, the backscatter capability report indicates that a frequency shift capability at the UE is enabled or disabled.

In some examples, the energy state manager 940 may be configured as or otherwise support a means for determining one or more of an energy state or an available power at the UE. In some examples, the backscatter communications manager 930 may be configured as or otherwise support a means for requesting to disable communications with the network node using frequency shifted backscatter modulation based on one or more of the energy state or the available power at the UE. In some examples, the backscatter capability report further includes a requested amount of power of an interrogation signal from the network node for performing backscatter modulation with a frequency shift.

In some examples, the backscatter signal generation manager 945 may be configured as or otherwise support a means for indicating that the UE performs frequency shifting of the reflected signal from the UE using a square wave generated at the UE or a sinusoidal wave generated using a local oscillator of the UE. In some examples, the backscatter capability report further indicates one or more parameters associated with a frequency or clock stability, an expected offset between the frequency or clock and an interrogation signal frequency, or any combinations thereof. In some examples, the backscatter capability report further indicates, for frequency shifting using the square wave, one or more of a jitter range or the expected offset associated with generating the square wave.

In some examples, the backscatter capability report further indicates, for frequency shifting using the local oscillator, one or more of a phase noise class or the expected offset associated with generating the sinusoidal wave. In some examples, the frequency shift manager 935 may be configured as or otherwise support a means for receiving an indication of one or more frequency shift parameters for the communicating with the network node.

In some examples, the frequency hopping manager 950 may be configured as or otherwise support a means for transmitting a backscatter capability report the indicates a frequency hopping capability of the UE for frequency shifting the reflected signal from the UE using backscatter modulation. In some examples, the frequency hopping capability includes an indication of one or more of a switching gap time supported at the UE, a number of frequency hops supported at the UE, one or more hopping patterns supported at the UE, or any combinations thereof.

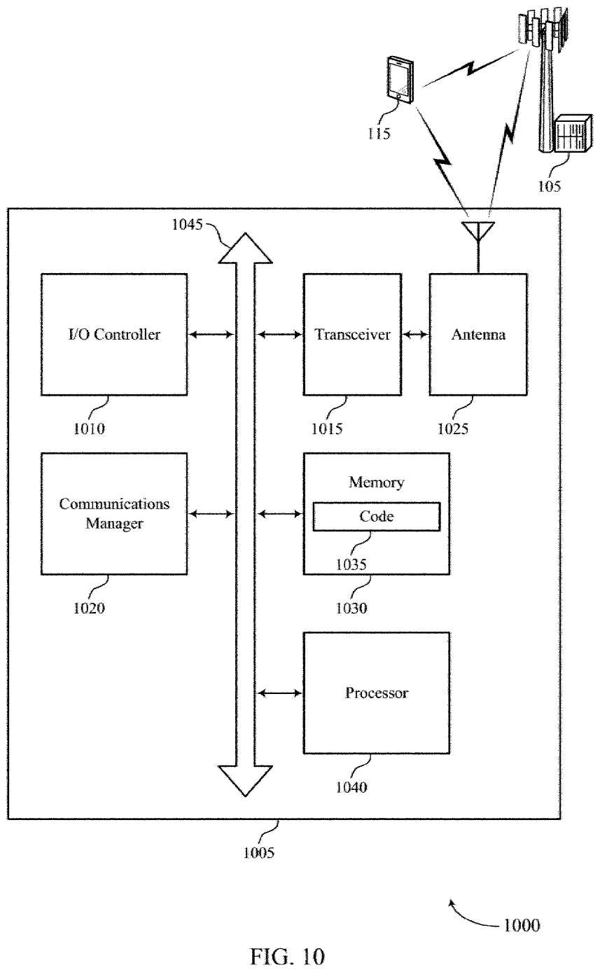

FIG. 10 illustrates a diagram of a system 1000 including a device 1005 that supports reporting techniques for backscatter capability with frequency shift in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting reporting techniques for backscatter capability with frequency shift). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for transmitting a backscatter capability report to a network node that includes one or more backscatter modulation capabilities of the UE, the one or more backscatter modulation capabilities including one or more frequency shift capabilities for frequency shifting a reflected signal using backscatter modulation. The communications manager 1020 may be configured as or otherwise support a means for communicating with the network node using backscatter modulation based on the one or more backscatter modulation capabilities of the UE indicated in the backscatter capability report.

By including or configuring the communications manager 1020 in accordance with examples as described herein, the device 1005 may support techniques for reporting frequency shifting capabilities for backscatter communications, which may provide for additional flexibility and capabilities of a system and provide for a wide variety of devices that implement low-cost and low-complexity connectivity (e.g., in IoT systems).

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of reporting techniques for backscatter capability with frequency shift as described herein, or the processor 1040 and the memory 1030 may be otherwise configured to perform or support such operations.

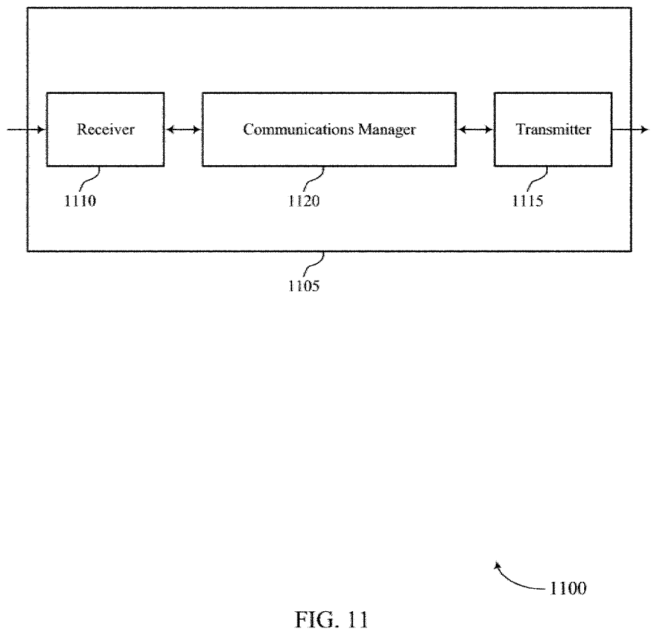

FIG. 11 illustrates a block diagram 1100 of a device 1105 that supports reporting techniques for backscatter capability with frequency shift in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of reporting techniques for backscatter capability with frequency shift as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network node in accordance with examples as disclosed herein. For example, the communications manager 1120 may be configured as or otherwise support a means for receiving, from a UE, a backscatter capability report that indicates one or more backscatter modulation capabilities of the UE, the one or more backscatter modulation capabilities including one or more frequency shift capabilities for frequency shifting a reflected signal using backscatter modulation. The communications manager 1120 may be configured as or otherwise support a means for communicating with the UE using backscatter modulation based on the one or more backscatter modulation capabilities of the UE indicated in the backscatter capability report.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for receiving reports of frequency shifting capabilities for backscatter communications, which may provide for additional flexibility and capabilities of a system and provide for a wide variety of devices that implement low-cost and low-complexity connectivity (e.g., in IoT systems).

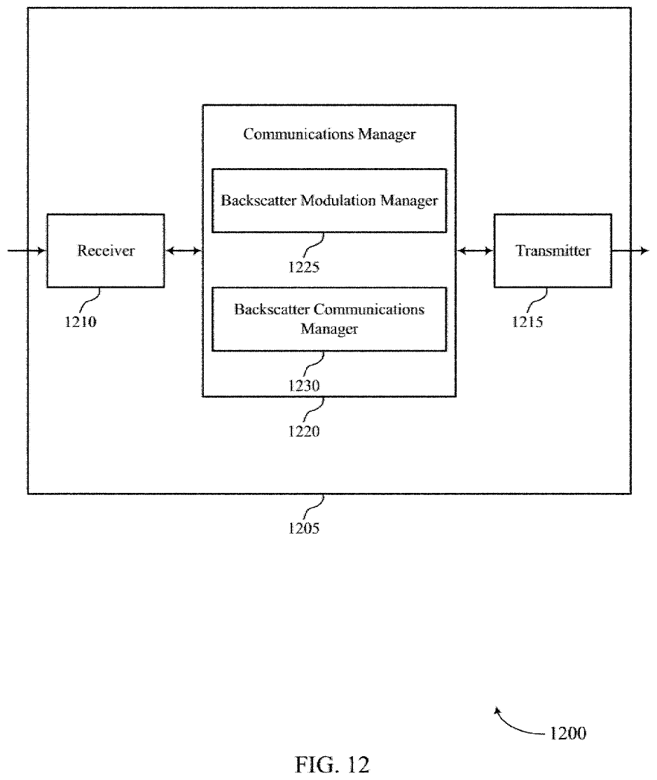

FIG. 12 illustrates a block diagram 1200 of a device 1205 that supports reporting techniques for backscatter capability with frequency shift in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of reporting techniques for backscatter capability with frequency shift as described herein. For example, the communications manager 1220 may include a backscatter modulation manager 1225 a backscatter communications manager 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network node in accordance with examples as disclosed herein. The backscatter modulation manager 1225 may be configured as or otherwise support a means for receiving, from a UE, a backscatter capability report that indicates one or more backscatter modulation capabilities of the UE, the one or more backscatter modulation capabilities including one or more frequency shift capabilities for frequency shifting a reflected signal using backscatter modulation. The backscatter communications manager 1230 may be configured as or otherwise support a means for communicating with the UE using backscatter modulation based on the one or more backscatter modulation capabilities of the UE indicated in the backscatter capability report.

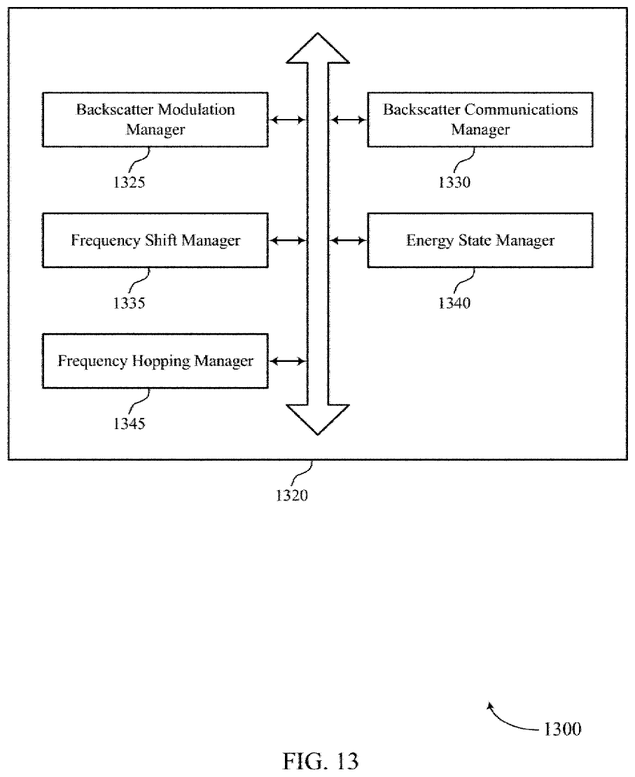

FIG. 13 illustrates a block diagram 1300 of a communications manager 1320 that supports reporting techniques for backscatter capability with frequency shift in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of reporting techniques for backscatter capability with frequency shift as described herein. For example, the communications manager 1320 may include a backscatter modulation manager 1325, a backscatter communications manager 1330, a frequency shift manager 1335, an energy state manager 1340, a frequency hopping manager 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network node in accordance with examples as disclosed herein. The backscatter modulation manager 1325 may be configured as or otherwise support a means for receiving, from a UE, a backscatter capability report that indicates one or more backscatter modulation capabilities of the UE, the one or more backscatter modulation capabilities including one or more frequency shift capabilities for frequency shifting a reflected signal using backscatter modulation. The backscatter communications manager 1330 may be configured as or otherwise support a means for communicating with the UE using backscatter modulation based on the one or more backscatter modulation capabilities of the UE indicated in the backscatter capability report.

In some examples, the backscatter communications manager 1330 may be configured as or otherwise support a means for transmitting a signal to the UE that requests the backscatter capability report. In some examples, the frequency shift manager 1335 may be configured as or otherwise support a means for receiving the backscatter capability report that indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof. In some examples, the backscatter capability report indicates an amount of frequency shift supported for frequency shifting the reflected signal from the UE using backscatter modulation.

In some examples, the backscatter communications manager 1330 may be configured as or otherwise support a means for transmitting, subsequent to the receiving the backscatter capability report, an interrogation signal that initiates backscatter modulated communications based on the one or more frequency shift capabilities of the UE, and where the communicating with the UE is responsive to the interrogation signal.

In some examples, the backscatter communications manager 1330 may be configured as or otherwise support a means for receiving a request to disable communications with the network node using frequency shifted backscatter modulation.

In some examples, the energy state manager 1340 may be configured as or otherwise support a means for identifying that the backscatter capability report further includes a requested amount of power of an interrogation signal from the network node, and a power of the interrogation signal is determined based on the requested amount of power. In some examples, the backscatter communications manager 1330 may be configured as or otherwise support a means for discontinuing communications with the UE using frequency shifted backscatter modulation.

In some examples, the backscatter capability report indicates that the UE performs frequency shifting of the reflected signal from the UE using a square wave generated at the UE or a sinusoidal wave generated using a local oscillator of the UE, and the communicating with the UE is based on the square wave or sinusoidal wave frequency shifting of the UE. In some examples, the frequency hopping manager 1345 may be configured as or otherwise support a means for identifying that the backscatter capability report indicates a frequency hopping capability of the UE for frequency shifting the reflected signal from the UE using backscatter modulation.

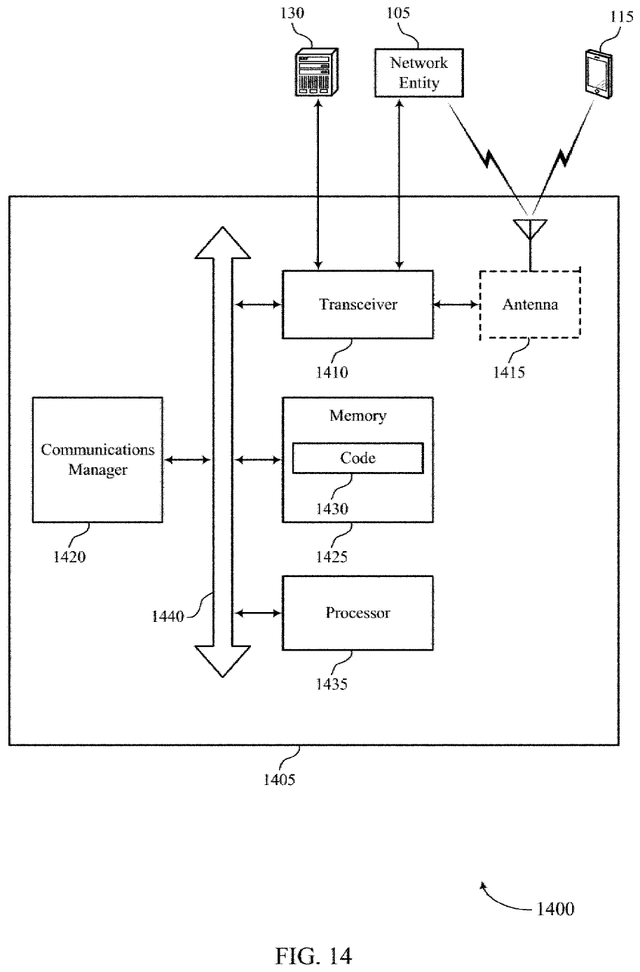

FIG. 14 illustrates a diagram of a system 1400 including a device 1405 that supports reporting techniques for backscatter capability with frequency shift in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting reporting techniques for backscatter capability with frequency shift). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network node in accordance with examples as disclosed herein. For example, the communications manager 1420 may be configured as or otherwise support a means for receiving, from a UE, a backscatter capability report that indicates one or more backscatter modulation capabilities of the UE, the one or more backscatter modulation capabilities including one or more frequency shift capabilities for frequency shifting a reflected signal using backscatter modulation. The communications manager 1420 may be configured as or otherwise support a means for communicating with the UE using backscatter modulation based on the one or more backscatter modulation capabilities of the UE indicated in the backscatter capability report.

By including or configuring the communications manager 1420 in accordance with examples as described herein, the device 1405 may support techniques for receiving reports of frequency shifting capabilities for backscatter communications, which may provide for additional flexibility and capabilities of a system and provide for a wide variety of devices that implement low-cost and low-complexity connectivity (e.g., in IoT systems).

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of reporting techniques for backscatter capability with frequency shift as described herein, or the processor 1435 and the memory 1425 may be otherwise configured to perform or support such operations.

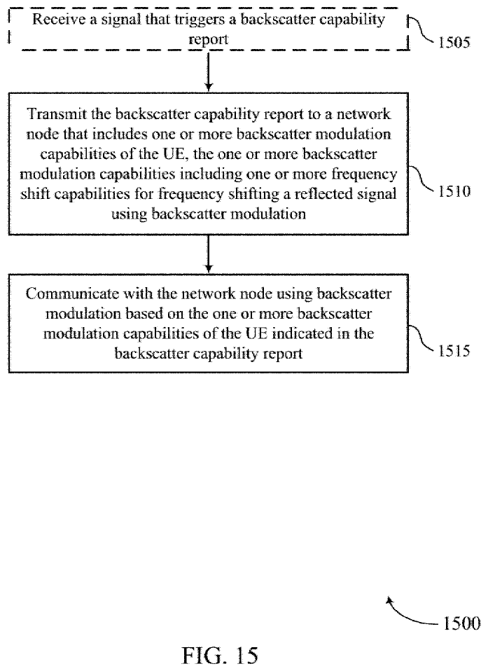

FIG. 15 illustrates a flowchart showing a method 1500 that supports reporting techniques for backscatter capability with frequency shift in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

Optionally, at 1505, the method may include receiving a signal that triggers a backscatter capability report. The operations of 1505 may be performed in accordance with examples as disclosed herein. In some examples, aspects of the operations of 1505 may be performed by a backscatter communications manager 930 as described with reference to FIG. 9.

At 1510, the method may include transmitting the backscatter capability report to a network node that includes one or more backscatter modulation capabilities of the UE, the one or more backscatter modulation capabilities including one or more frequency shift capabilities for frequency shifting a reflected signal using backscatter modulation. The operations of 1510 may be performed in accordance with examples as disclosed herein. In some examples, aspects of the operations of 1510 may be performed by a backscatter modulation manager 925 as described with reference to FIG. 9.

At 1515, the method may include communicating with the network node using backscatter modulation based on the one or more backscatter modulation capabilities of the UE indicated in the backscatter capability report. The operations of 1515 may be performed in accordance with examples as disclosed herein. In some examples, aspects of the operations of 1515 may be performed by a backscatter communications manager 930 as described with reference to FIG. 9.

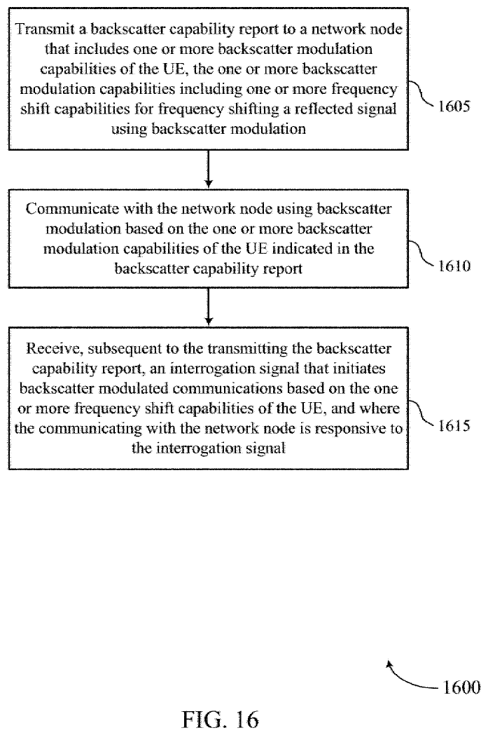

FIG. 16 illustrates a flowchart showing a method 1600 that supports reporting techniques for backscatter capability with frequency shift in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting a backscatter capability report to a network node that includes one or more backscatter modulation capabilities of the UE, the one or more backscatter modulation capabilities including one or more frequency shift capabilities for frequency shifting a reflected signal using backscatter modulation. The operations of 1605 may be performed in accordance with examples as disclosed herein. In some examples, aspects of the operations of 1605 may be performed by a backscatter modulation manager 925 as described with reference to FIG. 9.

At 1610, the method may include communicating with the network node using backscatter modulation based on the one or more backscatter modulation capabilities of the UE indicated in the backscatter capability report. The operations of 1610 may be performed in accordance with examples as disclosed herein. In some examples, aspects of the operations of 1610 may be performed by a backscatter communications manager 930 as described with reference to FIG. 9.

At 1615, the method may include receiving, subsequent to the transmitting the backscatter capability report, an interrogation signal that initiates backscatter modulated communications based on the one or more frequency shift capabilities of the UE, and where the communicating with the network node is responsive to the interrogation signal. The operations of 1615 may be performed in accordance with examples as disclosed herein. In some examples, aspects of the operations of 1615 may be performed by a backscatter communications manager 930 as described with reference to FIG. 9.

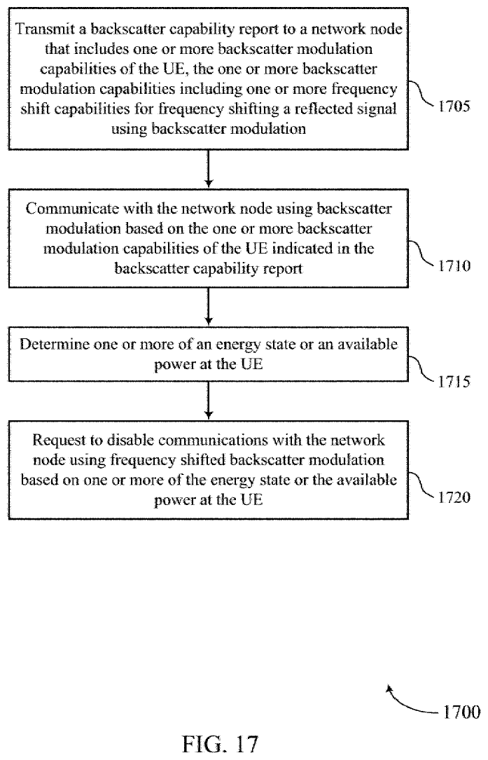

FIG. 17 illustrates a flowchart showing a method 1700 that supports reporting techniques for backscatter capability with frequency shift in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a backscatter capability report to a network node that includes one or more backscatter modulation capabilities of the UE, the one or more backscatter modulation capabilities including one or more frequency shift capabilities for frequency shifting a reflected signal using backscatter modulation. The operations of 1705 may be performed in accordance with examples as disclosed herein. In some examples, aspects of the operations of 1705 may be performed by a backscatter modulation manager 925 as described with reference to FIG. 9.

At 1710, the method may include communicating with the network node using backscatter modulation based on the one or more backscatter modulation capabilities of the UE indicated in the backscatter capability report. The operations of 1710 may be performed in accordance with examples as disclosed herein. In some examples, aspects of the operations of 1710 may be performed by a backscatter communications manager 930 as described with reference to FIG. 9.

At 1715, the method may include determining one or more of an energy state or an available power at the UE. The operations of 1715 may be performed in accordance with examples as disclosed herein. In some examples, aspects of the operations of 1715 may be performed by an energy state manager 940 as described with reference to FIG. 9.

At 1720, the method may include requesting to disable communications with the network node using frequency shifted backscatter modulation based on one or more of the energy state or the available power at the UE. The operations of 1720 may be performed in accordance with examples as disclosed herein. In some examples, aspects of the operations of 1720 may be performed by a backscatter communications manager 930 as described with reference to FIG. 9.

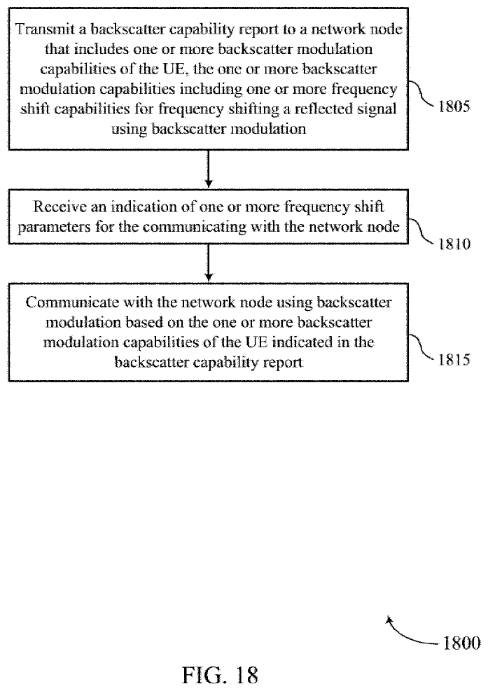

FIG. 18 illustrates a flowchart showing a method 1800 that supports reporting techniques for backscatter capability with frequency shift in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting a backscatter capability report to a network node that includes one or more backscatter modulation capabilities of the UE, the one or more backscatter modulation capabilities including one or more frequency shift capabilities for frequency shifting a reflected signal using backscatter modulation. The operations of 1805 may be performed in accordance with examples as disclosed herein. In some examples, aspects of the operations of 1805 may be performed by a backscatter modulation manager 925 as described with reference to FIG. 9.

At 1810, the method may include receiving an indication of one or more frequency shift parameters for the communicating with the network node. The operations of 1810 may be performed in accordance with examples as disclosed herein. In some examples, aspects of the operations of 1810 may be performed by a frequency shift manager 935 as described with reference to FIG. 9.

At 1815, the method may include communicating with the network node using backscatter modulation based on the one or more backscatter modulation capabilities of the UE indicated in the backscatter capability report. The operations of 1815 may be performed in accordance with examples as disclosed herein. In some examples, aspects of the operations of 1815 may be performed by a backscatter communications manager 930 as described with reference to FIG. 9.

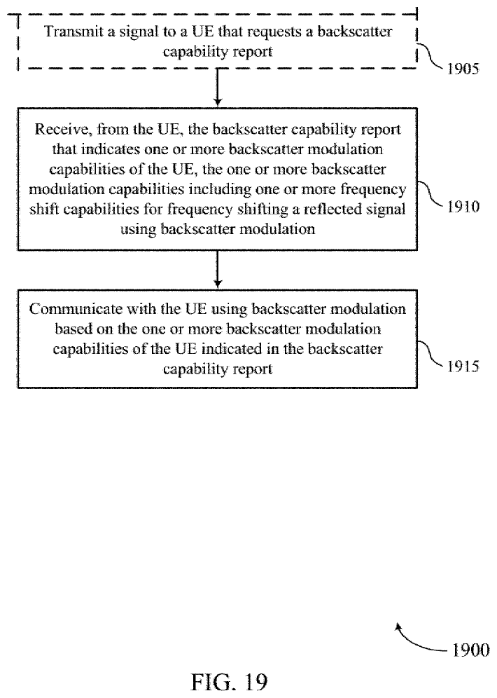

FIG. 19 illustrates a flowchart showing a method 1900 that supports reporting techniques for backscatter capability with frequency shift in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

Optionally, at 1905, the method may include transmitting a signal to a UE that requests a backscatter capability report. The operations of 1905 may be performed in accordance with examples as disclosed herein. In some examples, aspects of the operations of 1905 may be performed by a backscatter communications manager 1330 as described with reference to FIG. 13.

At 1910, the method may include receiving, from the UE, the backscatter capability report that indicates one or more backscatter modulation capabilities of the UE, the one or more backscatter modulation capabilities including one or more frequency shift capabilities for frequency shifting a reflected signal using backscatter modulation. The operations of 1910 may be performed in accordance with examples as disclosed herein. In some examples, aspects of the operations of 1910 may be performed by a backscatter modulation manager 1325 as described with reference to FIG. 13.

At 1915, the method may include communicating with the UE using backscatter modulation based on the one or more backscatter modulation capabilities of the UE indicated in the backscatter capability report. The operations of 1915 may be performed in accordance with examples as disclosed herein. In some examples, aspects of the operations of 1915 may be performed by a backscatter communications manager 1330 as described with reference to FIG. 13.

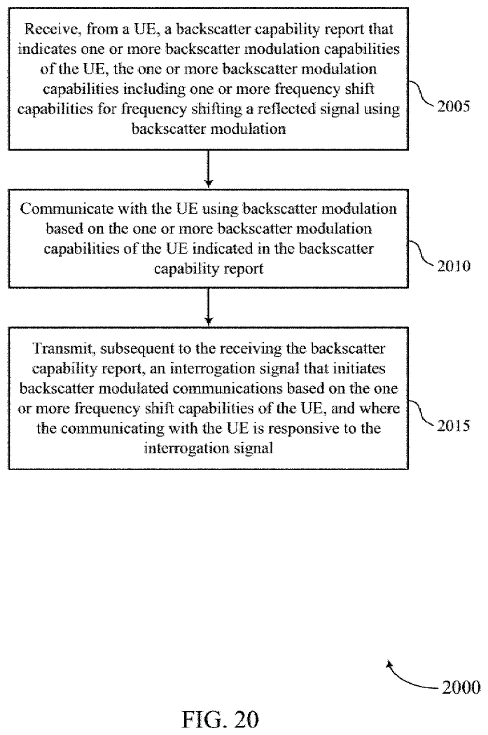

FIG. 20 illustrates a flowchart showing a method 2000 that supports reporting techniques for backscatter capability with frequency shift in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include receiving, from a UE, a backscatter capability report that indicates one or more backscatter modulation capabilities of the UE, the one or more backscatter modulation capabilities including one or more frequency shift capabilities for frequency shifting a reflected signal using backscatter modulation. The operations of 2005 may be performed in accordance with examples as disclosed herein. In some examples, aspects of the operations of 2005 may be performed by a backscatter modulation manager 1325 as described with reference to FIG. 13.

At 2010, the method may include communicating with the UE using backscatter modulation based on the one or more backscatter modulation capabilities of the UE indicated in the backscatter capability report. The operations of 2010 may be performed in accordance with examples as disclosed herein. In some examples, aspects of the operations of 2010 may be performed by a backscatter communications manager 1330 as described with reference to FIG. 13.

At 2015, the method may include transmitting, subsequent to the receiving the backscatter capability report, an interrogation signal that initiates backscatter modulated communications based on the one or more frequency shift capabilities of the UE, and where the communicating with the UE is responsive to the interrogation signal. The operations of 2015 may be performed in accordance with examples as disclosed herein. In some examples, aspects of the operations of 2015 may be performed by a backscatter communications manager 1330 as described with reference to FIG. 13.

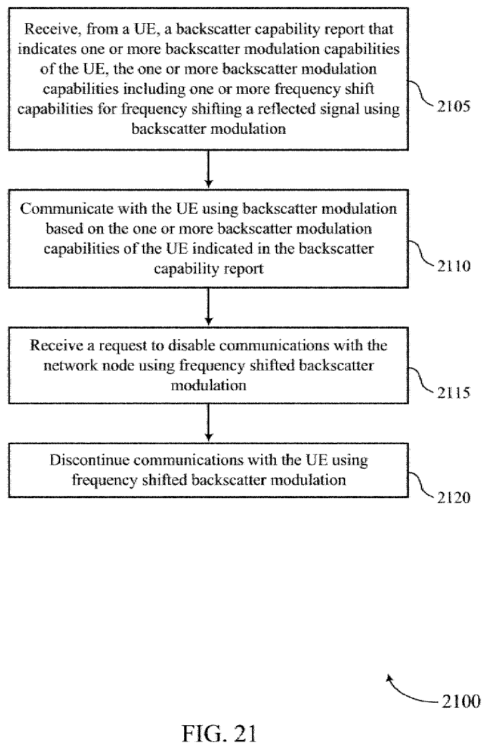

FIG. 21 illustrates a flowchart showing a method 2100 that supports reporting techniques for backscatter capability with frequency shift in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include receiving, from a UE, a backscatter capability report that indicates one or more backscatter modulation capabilities of the UE, the one or more backscatter modulation capabilities including one or more frequency shift capabilities for frequency shifting a reflected signal using backscatter modulation. The operations of 2105 may be performed in accordance with examples as disclosed herein. In some examples, aspects of the operations of 2105 may be performed by a backscatter modulation manager 1325 as described with reference to FIG. 13.

At 2110, the method may include communicating with the UE using backscatter modulation based on the one or more backscatter modulation capabilities of the UE indicated in the backscatter capability report. The operations of 2110 may be performed in accordance with examples as disclosed herein. In some examples, aspects of the operations of 2110 may be performed by a backscatter communications manager 1330 as described with reference to FIG. 13.

At 2115, the method may include receiving a request to disable communications with the network node using frequency shifted backscatter modulation. The operations of 2115 may be performed in accordance with examples as disclosed herein. In some examples, aspects of the operations of 2115 may be performed by a backscatter communications manager 1330 as described with reference to FIG. 13.

At 2120, the method may include discontinuing communications with the UE using frequency shifted backscatter modulation. The operations of 2120 may be performed in accordance with examples as disclosed herein. In some examples, aspects of the operations of 2120 may be performed by a backscatter communications manager 1330 as described with reference to FIG. 13.

The following provides an overview of aspects of the present disclosure:

Aspect 1: A method for wireless communication at a UE, comprising: transmitting a backscatter capability report to a network node that includes one or more backscatter modulation capabilities of the UE, the one or more backscatter modulation capabilities including one or more frequency shift capabilities for frequency shifting a reflected signal using backscatter modulation; and communicating with the network node using backscatter modulation based at least in part on the one or more backscatter modulation capabilities of the UE indicated in the backscatter capability report.

Aspect 2: The method of aspect 1, further comprising: receiving a signal that triggers the backscatter capability report, and wherein the transmitting is responsive to the signal.

Aspect 3: The method of any of aspects 1 through 2, wherein the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof.

Aspect 4: The method of any of aspects 1 through 3, further comprising: receiving, subsequent to the transmitting the backscatter capability report, an interrogation signal that initiates backscatter modulated communications based on the one or more frequency shift capabilities of the UE, and wherein the communicating with the network node is responsive to the interrogation signal.

Aspect 5: The method of any of aspects 1 through 4, wherein the backscatter capability report indicates that a frequency shift capability at the UE is enabled or disabled.

Aspect 6: The method of any of aspects 1 through 5, further comprising: determining one or more of an energy state or an available power at the UE; and requesting to disable communications with the network node using frequency shifted backscatter modulation based at least in part on one or more of the energy state or the available power at the UE.

Aspect 7: The method of any of aspects 1 through 6, wherein the backscatter capability report further includes a requested amount of power of an interrogation signal from the network node for performing backscatter modulation with a frequency shift.

Aspect 8: The method of any of aspects 1 through 7, wherein the backscatter capability report indicates that the UE performs frequency shifting of the reflected signal from the UE using a square wave generated at the UE or a sinusoidal wave generated using a local oscillator of the UE.

Aspect 9: The method of aspect 8, wherein the backscatter capability report further indicates one or more parameters associated with a frequency or clock stability, an expected offset between the frequency or clock and an interrogation signal frequency, or any combinations thereof.

Aspect 10: The method of aspect 9, wherein the backscatter capability report further indicates, for frequency shifting using the square wave, one or more of a jitter range or the expected offset associated with generating the square wave.

Aspect 11: The method of any of aspects 9 through 10, wherein the backscatter capability report further indicates, for frequency shifting using the local oscillator, one or more of a phase noise class or the expected offset associated with generating the sinusoidal wave.

Aspect 12: The method of any of aspects 1 through 11, further comprising: receiving an indication of one or more frequency shift parameters for the communicating with the network node.

Aspect 13: The method of any of aspects 1 through 12, wherein the backscatter capability report indicates a frequency hopping capability of the UE for frequency shifting the reflected signal from the UE using backscatter modulation.

Aspect 14: The method of aspect 13, wherein the frequency hopping capability includes an indication of one or more of a switching gap time supported at the UE, a number of frequency hops supported at the UE, one or more hopping patterns supported at the UE, or any combinations thereof.

Aspect 15: A method for wireless communication at a network node, comprising: receiving, from a UE, a backscatter capability report that indicates one or more backscatter modulation capabilities of the UE, the one or more backscatter modulation capabilities including one or more frequency shift capabilities for frequency shifting a reflected signal using backscatter modulation; and communicating with the UE using backscatter modulation based at least in part on the one or more backscatter modulation capabilities of the UE indicated in the backscatter capability report.

Aspect 16: The method of aspect 15, further comprising: transmitting a signal to the UE that requests the backscatter capability report.

Aspect 17: The method of any of aspects 15 through 16, wherein the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof.

Aspect 18: The method of any of aspects 15 through 17, further comprising: transmitting, subsequent to the receiving the backscatter capability report, an interrogation signal that initiates backscatter modulated communications based on the one or more frequency shift capabilities of the UE, and wherein the communicating with the UE is responsive to the interrogation signal.

Aspect 19: The method of any of aspects 15 through 18, further comprising: receiving a request to disable communications with the network node using frequency shifted backscatter modulation; and discontinuing communications with the UE using frequency shifted backscatter modulation.

Aspect 20: The method of any of aspects 15 through 19, wherein the backscatter capability report further includes a requested amount of power of an interrogation signal from the network node, and a power of the interrogation signal is determined based at least in part on the requested amount of power.

Aspect 21: The method of any of aspects 15 through 20, wherein the backscatter capability report indicates that the UE performs frequency shifting of the reflected signal from the UE using a square wave generated at the UE or a sinusoidal wave generated using a local oscillator of the UE, and the communicating with the UE is based at least in part on the square wave or sinusoidal wave frequency shifting of the UE.

Aspect 22: The method of any of aspects 15 through 21, wherein the backscatter capability report indicates an amount of frequency shift supported for frequency shifting the reflected signal from the UE using backscatter modulation.

Aspect 23: The method of any of aspects 15 through 22, wherein the backscatter capability report indicates a frequency hopping capability of the UE for frequency shifting the reflected signal from the UE using backscatter modulation.

Aspect 24: An apparatus for wireless communication at a UE, comprising a processor; memory coupled with the processor; and instructions stored in the memory and executable by the processor to cause the apparatus to perform a method of any of aspects 1 through 14.

Aspect 25: An apparatus for wireless communication at a UE, comprising at least one means for performing a method of any of aspects 1 through 14.

Aspect 26: A non-transitory computer-readable medium storing code for wireless communication at a UE, the code comprising instructions executable by a processor to perform a method of any of aspects 1 through 14.

Aspect 27: An apparatus for wireless communication at a network node, comprising a processor; memory coupled with the processor; and instructions stored in the memory and executable by the processor to cause the apparatus to perform a method of any of aspects 15 through 23.

Aspect 28: An apparatus for wireless communication at a network node, comprising at least one means for performing a method of any of aspects 15 through 23.

Aspect 29: A non-transitory computer-readable medium storing code for wireless communication at a network node, the code comprising instructions executable by a processor to perform a method of any of aspects 15 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
transmitting a backscatter capability report to a network node that includes one or more backscatter modulation capabilities of the UE, the one or more backscatter modulation capabilities including one or more frequency shift capabilities for frequency shifting a reflected signal using backscatter modulation; and
communicating with the network node using backscatter modulation based at least in part on the one or more backscatter modulation capabilities of the UE indicated in the backscatter capability report.

2. The method of claim 1, further comprising:
receiving a signal that triggers the backscatter capability report, and wherein the transmitting is responsive to the signal.

3. The method of claim 1, wherein the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof.

4. The method of claim 1, further comprising:
receiving, subsequent to the transmitting the backscatter capability report, an interrogation signal that initiates backscatter modulated communications based on the one or more frequency shift capabilities of the UE, and wherein the communicating with the network node is responsive to the interrogation signal.

5. The method of claim 1, wherein the backscatter capability report indicates that a frequency shift capability at the UE is enabled or disabled.

6. The method of claim 1, further comprising:
determining one or more of an energy state or an available power at the UE; and
requesting to disable communications with the network node using frequency shifted backscatter modulation based at least in part on one or more of the energy state or the available power at the UE.

7. The method of claim 1, wherein the backscatter capability report further includes a requested amount of power of an interrogation signal from the network node for performing backscatter modulation with a frequency shift.

8. The method of claim 1, wherein the backscatter capability report indicates that the UE performs frequency shifting of the reflected signal from the UE using a square wave generated at the UE or a sinusoidal wave generated using a local oscillator of the UE.

9. The method of claim 8, wherein the backscatter capability report further indicates one or more parameters associated with a frequency or clock stability, an expected offset between the frequency or clock and an interrogation signal frequency, or any combinations thereof.

10. The method of claim 9, wherein the backscatter capability report further indicates, for frequency shifting using the square wave, one or more of a jitter range or the expected offset associated with generating the square wave.

11. The method of claim 9, wherein the backscatter capability report further indicates, for frequency shifting using the local oscillator, one or more of a phase noise class or the expected offset associated with generating the sinusoidal wave.

12. The method of claim 1, further comprising:
receiving an indication of one or more frequency shift parameters for the communicating with the network node.

13. The method of claim 1, wherein the backscatter capability report indicates a frequency hopping capability of the UE for frequency shifting the reflected signal from the UE using backscatter modulation.

14. The method of claim 13, wherein the frequency hopping capability includes an indication of one or more of a switching gap time supported at the UE, a number of frequency hops supported at the UE, one or more hopping patterns supported at the UE, or any combinations thereof.

15. A method for wireless communication at a network node, comprising:
receiving, from a user equipment (UE), a backscatter capability report that indicates one or more backscatter modulation capabilities of the UE, the one or more backscatter modulation capabilities including one or more frequency shift capabilities for frequency shifting a reflected signal using backscatter modulation; and communicating with the UE using backscatter modulation based at least in part on the one or more backscatter modulation capabilities of the UE indicated in the backscatter capability report.

16. (canceled)

17. (canceled)

18. (canceled)

19. (canceled)

20. (canceled)

21. (canceled)

22. (canceled)

23. (canceled)

24. An apparatus for wireless communication at a user equipment (UE), comprising:
a processor;
memory coupled with the processor; and
instructions stored in the memory and executable by the processor to cause the apparatus to:
transmit a backscatter capability report to a network node that includes one or more backscatter modulation capabilities of the UE, the one or more backscatter modulation capabilities including one or more frequency shift capabilities for frequency shifting a reflected signal using backscatter modulation; and
communicate with the network node using backscatter modulation based at least in part on the one or more backscatter modulation capabilities of the UE indicated in the backscatter capability report.

25. The apparatus of claim 24, wherein the instructions are further executable by the processor to cause the apparatus to: receive a signal that triggers the backscatter capability report, and wherein the transmitting is responsive to the signal.

26. The apparatus of claim 24, wherein the backscatter capability report indicates one or more of whether frequency shifting is supported at the UE, an amount of a frequency shift that is supported at the UE, two or more discrete frequency shifts that are supported at the UE, a double-side frequency shift capability, a single-side frequency shift capability, or any combinations thereof.

27. The apparatus of claim 24, wherein the instructions are further executable by the processor to cause the apparatus to:
determine one or more of an energy state or an available power at the UE; and request to disable communications with the network node using frequency shifted backscatter modulation based at least in part on one or more of the energy state or the available power at the UE.

28. An apparatus for wireless communication at a network node, comprising:
a processor;
memory coupled with the processor; and
instructions stored in the memory and executable by the processor to cause the apparatus to:
receive, from a user equipment (UE), a backscatter capability report that indicates one or more backscatter modulation capabilities of the UE, the one or more backscatter modulation capabilities including one or more frequency shift capabilities for frequency shifting a reflected signal using backscatter modulation; and
communicate with the UE using backscatter modulation based at least in part on the one or more backscatter modulation capabilities of the UE indicated in the backscatter capability report.

29. (canceled)

30. (canceled)
